(19) United States
(12) Patent Application Publication
(10) Pub. No.: US 2024/0009867 A1
(43) Pub. Date: Jan. 11, 2024

(54) ROBOT SYSTEM

(71) Applicant: SEIKO EPSON CORPORATION, Tokyo (JP)

(72) Inventors: Fuyumi TAKATA, AZUMINO-SHI (JP); Eiji INOMATA, MATSUMOTO-SHI (JP); Yuki KOBARI, MATSUMOTO-SHI (JP)

(21) Appl. No.: 18/218,601

(22) Filed: Jul. 6, 2023

(30) Foreign Application Priority Data
Jul. 7, 2022 (JP) 2022-109651

(51) Int. Cl. B25J 19/00; B25J 9/16

(52) U.S. Cl. CPC B25J 19/00; B25J 9/1674

(57) ABSTRACT

A robot system includes a robot and a robot controller that controls an operation and a temperature of the robot. The robot includes a first joint, a second joint, a first drive mechanism that drives the first joint, and a second drive mechanism that drives the second joint. A temperature adjuster includes a temperature sensor that measures a first temperature of the first drive mechanism, a heater that heats the first drive mechanism, a temperature sensor that measures a second temperature of the second drive mechanism, a heater that heats the second drive mechanism, and an adjustment section that controls the heater so that the first temperature of the first drive mechanism approaches a first target value set in advance, and that controls the heater so that the second temperature of the second drive mechanism approaches a second target value set in advance.

The present application is based on, and claims priority from JP Application Serial Number 2022-109651, filed Jul. 7, 2022, the disclosure of which is hereby incorporated by reference herein in its entirety.

### BACKGROUND

### 1. Technical Field

The present disclosure relates to a robot system.

### 2. Related Art

In some cases, a robot arm is caused to perform work similar to that performed by a human. In such a robot arm, a plurality of arm elements are coupled by joints. In order to smooth the movement of the joint, as described in JP-A-2020-116716, a lubricant is used for an actuator provided in the joint.

In addition, there is a demand for the robot arm to perform work instead of the human in a low temperature environment that is a relatively harsh environment for the human to perform work, such as a production line for frozen foods.

However, in a case where the low temperature environment is not assumed as a work environment and the robot arm that performs work in a normal temperature environment is installed as is in the low temperature environment, a conceivable problem is that smooth operation of the robot arm becomes difficult due to an increase in viscosity of the lubricant and a conceivable problem is that the robot arm cannot operate when the lubricant solidifies.

### SUMMARY

According to an aspect of the present disclosure, a robot system is provided. This robot system includes a robot arm and a control section that controls an operation of the robot arm and a temperature of the robot arm. The robot arm includes a first joint, a second joint that is different from the first joint, a first driving section that drives the first joint, and a second drive section, that is different from the first drive section and that drives the second joint. The control section includes a first temperature measurement section that measures a first temperature of the first drive section, a first heating section that heats the first drive section, a second temperature measurement section that is different from the first temperature measurement section and that measures a second temperature of the second drive section, a second heating section that is different from the first heating section and that heats the second drive section, and an adjustment section that controls heat generation of the first heating section so as to bring the first temperature of the first drive section close to a first target value set in advance and that controls heat generation of the second heating section that the second temperature of the second drive section approaches a second target value set in advance.

### BRIEF DESCRIPTION OF THE DRAWINGS

FIG. 1 is a schematic diagram showing an overall configuration of a robot system.

FIG. 2 is a block diagram showing main parts of the robot and the robot controller.

FIG. 3 is an exploded perspective view of an arm element.

FIG. 4 is a partial cross-sectional view of the arm element cut along a line 4-4 shown in FIG. 3.

FIG. 5 is a side view of the arm element shown in FIG. 3.

FIG. 6 is a side view of the arm element shown in FIG. 3 from another direction.

FIG. 7 is a side view of another example of the arm element.

### DESCRIPTION OF EMBODIMENTS

### A1. Embodiment

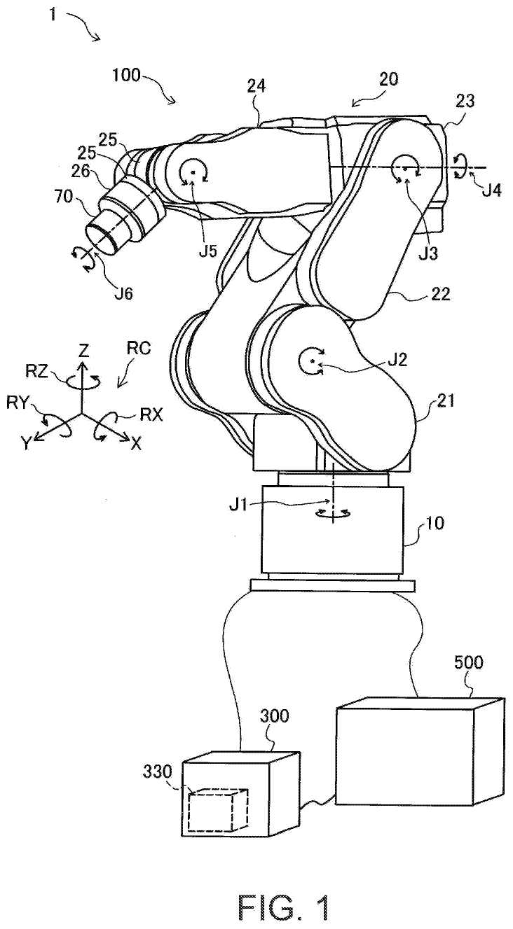

FIG. 1 is a schematic diagram showing an overall configuration of a robot system 1 according to the present embodiment. The robot system 1 includes a robot 100, a temperature adjuster 300, and a robot controller 500. The robot 100 is also referred to as a robot arm. The robot 100 is a vertically articulated robot. The robot 100 performs work related to manufacturing of food in a food factory. In the embodiment, it is assumed that the robot 100 is installed in a low temperature environment and performs work in the low temperature environment. Low temperature environment refers to an environment of 10° C. or lower, such as in a refrigerator of a refrigerated warehouse, and particularly in the present specification, refers to an environment of −18° C. or lower, such as in a freezer of a freezer warehouse. It is assumed that the temperature adjuster 300 and the robot controller 500 are installed in the normal temperature environment. In the present specification, the normal temperature environment refers to an environment in the range of 15 to 25° C. such as outside the refrigerator of the refrigerated warehouse or outside the freezer of the freezer warehouse.

The robot controller 500 is connected to an arm 20 and an end effector of the robot via a signal line. The robot controller 500 controls position of a control point of the robot 100 in a robot coordinate system RC. The control point of the robot 100 is set, for example, at a center of a point at which the end effector 70 touches an object. The control point may be referred to as a tool center point (TCP). The robot controller 500 drives the robot 100 to change the position and posture of the robot 100. Therefore, the robot controller 500 can dispose the end effector 70 attached to the tip end of the arm 20 of the robot 100 at a specified position in a specified posture. For example, the robot controller 500 can communicate with a control device (not shown), and controls the arm 20 and the end effector 70 of the robot 100 in accordance with an operation command received from the control device. The control device is, for example, a programmable logic controller.

In the embodiment, the coordinate system that defines a space in which the robot 100 is installed with reference to the position of a base 10 is represented as the robot coordinate system RC. The robot coordinate system RC is a three dimensional orthogonal coordinate system defined by an X-axis and a Y-axis orthogonal to each other and a Z-axis having a vertically upward direction as a positive direction on a horizontal plane. An arbitrary position in the robot coordinate system RC can be represented by a position in the X-axis direction, a position in the Y-axis direction, and a position in the Z-axis direction. The angular position of rotation about the X-axis is denoted by RX, the angular position of rotation about the Y-axis is denoted by RY, and the angular position of rotation about the Z-axis is denoted by RZ. An arbitrary posture in the robot coordinate system RC can be expressed by an angular position RX, an angular position RY, and an angular position RZ.

The robot 100 includes the base 10, the arm 20, and the end effector 70. The base 10 supports members constituting the robot 100. By fixing the base 10 to a floor, the robot 100 is installed on the floor. Further, not shown in FIG. 1, the robot 100 is supplied with electric power from an external AC power source.

Arm 20 includes arm elements 21, 22, 23, 24, 25 and 26. The arm 20 includes six joints J1 to J6. The joints J1 to J6 are rotational joints. The arm element 21 is coupled to an upper end section of the base 10. A coupling section between the base 10 and the arm element 21 constitutes the joint J1. The arm element 21 rotates relative to the base 10 around a rotation axis of the joint J1. The arm element 22 is coupled to a tip end section of the arm element 21. A coupling section between the arm element 21 and the arm element 22 constitutes the joint J2. The arm element 22 rotates relative to the arm element 21 around a rotation axis of the joint J2. The arm element 23 is coupled to a tip end section of the arm element 22. A coupling section between the arm element 22 and the arm element 23 constitutes the joint J3. The arm element 23 rotates relative to the arm element 22 around a rotation axis of the joint J3. The arm element 24 is coupled to a tip end section of the arm element 23. A coupling section between the arm element 23 and the arm element 24 constitutes the joint J4. The arm element 24 rotates relative to the arm element 23 around a rotation axis of the joint J4. The arm element 25 is coupled to a tip end section of the arm element 24. A coupling section between the arm element 24 and the arm element 25 constitutes the joint J5. The arm element 25 rotates relative to the arm element 24 around a rotation axis of the joint J5. The arm element 26 is coupled to a tip end section of the arm element 25. A coupling section between the arm element 25 and the arm element 26 constitutes the joint J6. The arm element 26 rotates relative to the arm element 25 about a rotation axis of the joint J6. The joint J6 rotates around the rotation axis perpendicular to the rotation axis of the joint J5. Details of the configuration of the arm element will be described later.

The end effector 70 is attached to the arm element 26 via a force sensor (not shown). The end effector 70 is, for example, a device for gripping a work (not shown). In FIG. 1, to facilitate understanding of the technology, the end effector 70 is shown as a cylindrical member. The end effector 70 is controlled by the robot controller 500.

The temperature adjuster 300 adjusts the temperatures of six drive mechanisms 40 that drive the joints J1 to J6 of the arm 20 of the robot 100. Specifically, the temperature adjuster 300 heats the six drive mechanisms 40 by the corresponding heaters 320 so as to maintain a target temperature specified by the robot controller 500. The temperature adjuster 300 can individually perform temperature adjustment at six points. The temperature adjuster 300 includes six temperature sensors 310, six heaters 320, and an adjustment section 330. In FIG. 1, the six temperature sensors 310 and the six heaters 320 are not shown. The temperature adjuster 300 is connected to the robot controller 500 via a signal line. Further, not shown in FIG. 1, the temperature adjuster 300 is supplied with electric power from the external AC power source.

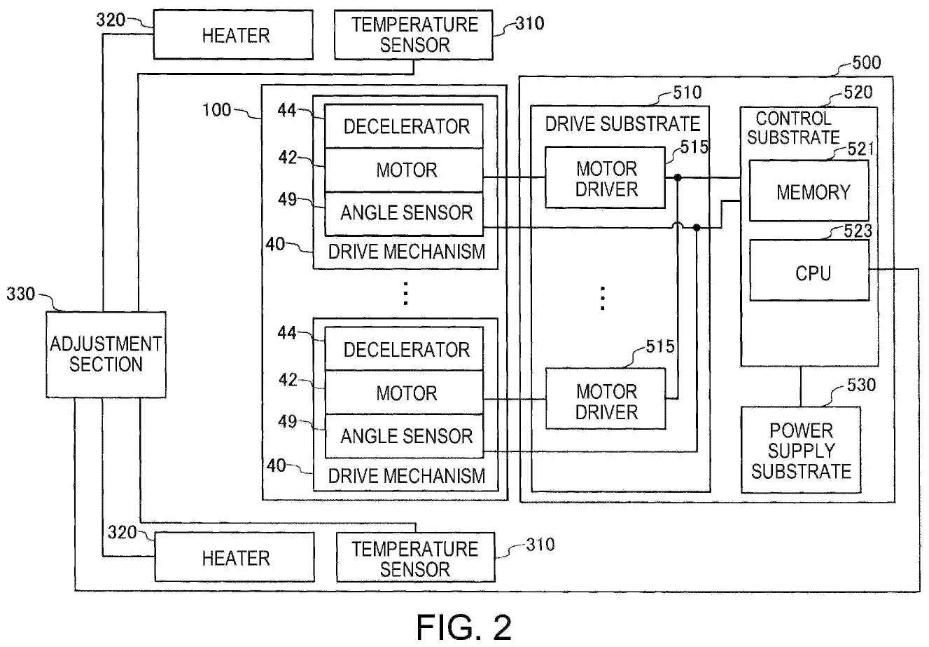

FIG. 2 is a block diagram showing main parts of the robot 100, the temperature adjuster 300, and the robot controller 500. Each drive mechanism 40 is assigned one temperature sensor 310 and one heater 320. In FIG. 2, only two drive mechanisms 40, two temperature sensors 310, and two heaters 320 are shown. The temperature sensors 310 are, for example, thermocouples or resistance thermometers. The temperature sensors 310 measure the temperature in the vicinity of the corresponding drive mechanism 40. In this specification, measuring the temperature of the drive mechanism 40 to which the temperature sensor 310 corresponds includes measuring the temperature in the vicinity of the drive mechanism 40 to which the temperature sensor 310 corresponds. The heater 320 is, for example, a heater in which a nichrome wire as a heat generator is covered with a metal film. The heater 320 generates heat by being supplied with a current. The heater 320 heats the corresponding drive mechanism 40. In this specification, heating the drive mechanism 40 to which the heater 320 corresponds includes heating the vicinity of the drive mechanism 40 to which the heater 320 corresponds. The six temperature sensors 310 and the six heaters 320 are provided at predetermined positions of the arm 20. Details of positions where the temperature sensor 310 and the heater 320 are disposed will be described later.

For each of the six drive mechanisms 40, the adjustment section 330 controls an amount of heat generation generated by each of the heaters 320 based on the temperatures measured by the temperature sensors 310 so that the temperatures of the drive mechanism 40 approach a target temperature. Controlling the amount of heat generation generated by the heater 320 also includes reducing the amount of heat generation generated to zero, that is, turning off the heater 320. A target temperature is a temperature that is desired to be maintained for the drive mechanism 40. The adjustment section 330 controls the amount of heat generation generated by the heater 320 by, for example, proportional integral differential (PID) control so that the measured temperature approaches the target temperature, that is, so that the deviation between the measured temperature and the target temperature approaches a value of zero. In this specification, an ambient temperature at which the robot 100 can normally operate is set to 0 to 45° C. The target temperature is desirably in a range of ambient temperatures at which the robot 100 can normally operate. For example, the target temperature is 10° C. Here, the amount of heat generation of the heater 320 refers to an amount of heat generation per unit time. The robot controller 500 and the temperature adjuster 300 are also collectively referred to as a control section. Further, the adjustment section 330 outputs the measured values of the temperatures measured by the six temperature sensors 310 to a control substrate 520 of the robot controller 500 at predetermined time intervals.

The robot controller 500 includes a drive substrate 510, the control substrate 520, and a power supply substrate 530. The drive substrate 510 includes six motor drivers 515. Each motor driver 515 drives a motor 42 of the corresponding drive mechanism 40 among the six drive mechanisms 40. The drive substrate 510 drives the six motors 42 under the control of the control substrate 520. The drive substrate 510 is disposed inside the arm 20.

The control substrate 520 includes a memory 521 and a central processing unit (CPU) 523. The memory 521 stores programs and data used for various processes executed by the robot controller 500. For example, an operation program for controlling the operation of the robot 100 and the target temperature value of each of the six drive mechanisms 40 are stored in the memory 521. The CPU 523 implements various functions by executing the program stored in the memory 521.

For example, the CPU 523 sets a target value indicating the target temperature for each of the six drive mechanisms 40 in the adjustment section 330 of the temperature adjuster 300. In the embodiment, it is assumed that the target temperatures of the six drive mechanisms 40 are the same. The robot controller 500 is also referred to as a control section.

The power supply substrate 530 converts electric power supplied from the external AC power source into DC power, and supplies the converted electric power to the control substrate 520. The power supply substrate 530 includes a circuit that steps down electric power supplied from the external AC power supply and converts the stepped down electric power into DC. The control substrate 520 and the power supply substrate 530 are disposed inside the housing of the robot controller 500.

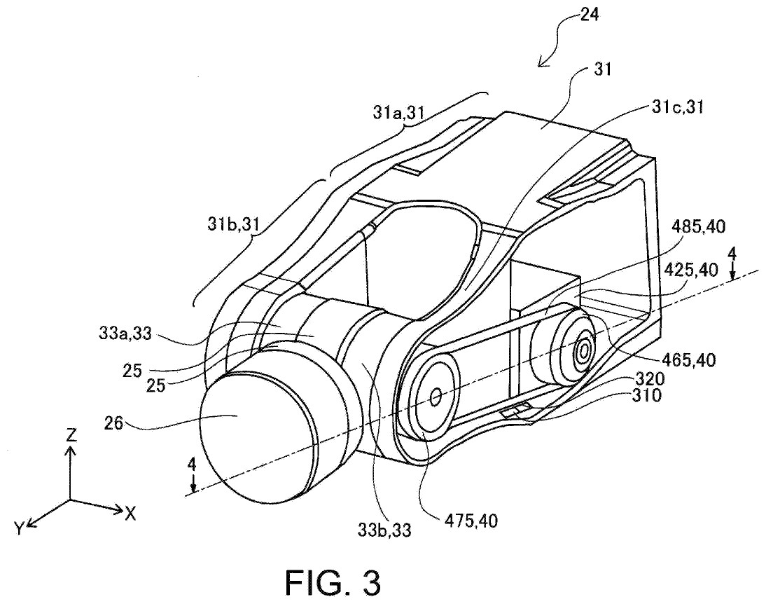

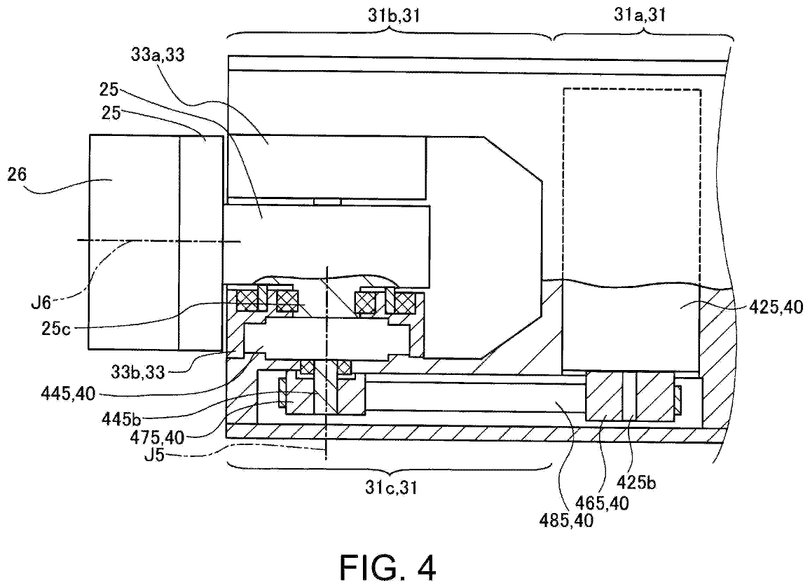

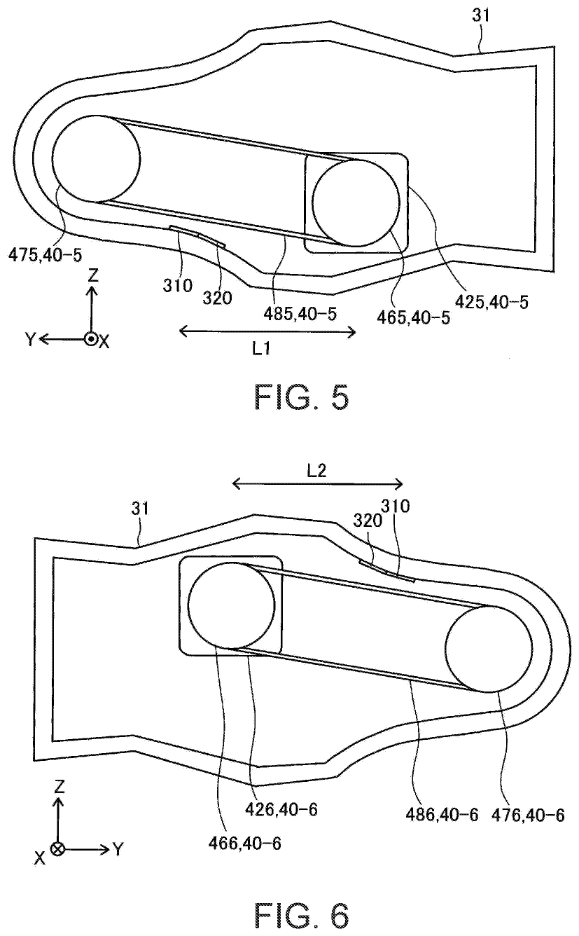

FIG. 3 is an exploded perspective view of the arm element 24. To facilitate understanding of the technology, illustration of a part of the configuration of the arm element 24 is omitted in FIG. 3. FIG. 4 is a partial cross-sectional view of the arm element 24 cut along a line 4-4 shown in FIG. 3. In FIGS. 3 and 4, illustration of the end effector 70 is omitted. FIG. 5 is a side view of the arm element 24 shown in FIG. 3 as viewed in the −X direction. FIG. 5 is a side view in a state where the side surface on the +X side of a main body 31 of the arm element 24 is removed. In FIG. 5, in order to show the positional relationship of a motor 425, a first pulley 465, a second pulley 475, and a belt 485, illustration of other components is omitted. In FIGS. 3 to 6, an orthogonal coordinate system different from the robot coordinate system RC is set for convenience. The orthogonal coordinate system set in FIGS. 3 to 6 is a coordinate system fixed with respect to the arm element 24.

The arm element 24 includes the main body 31, a coupling member 33, and the drive mechanism 40. The main body 31 is a hollow housing formed by aluminum or an aluminum alloy. As shown in FIGS. 3 and 4, in the arm element 24, the main body 31 includes a proximal section 31a, a first tip end section 31b, and a second tip end section 31c. The first tip end section 31b and the second tip end section 31c are formed so as to extend in the +Y direction from the proximal section 31a. The shapes of the main bodies 31 included in the arm elements other than the arm element 24 are configured according to the joints included in the respective arm elements.

The coupling member 33 is a member that couples the arm element 24 and the arm element 25. In the arm element 24, the coupling member 33 includes a cylindrical member 33a and a cylindrical member 33b. The arm element 25 is disposed between the first tip end section 31b and the second tip end section 31c. The cylindrical member 33a is disposed between the first tip end section 31b and the arm element 25. The cylindrical member 33a is fixed to the first tip end section 31b by being fitted into an opening formed in a side surface of the first tip end section 31b on the +X side. The cylindrical member 33b is disposed between the second tip end section 31c and the arm elements 25. The cylindrical member 33b is fixed to the second tip end section 31c by being fitted into an opening formed in a side surface of the second tip end section 31c on the −X side.

The first tip end section 31b and the second tip end section 31c and the cylindrical members 33a and 33b constitute a joint structure. The arm element 25 is held by the arm element 24 by sandwiching the arm element 25 between the cylindrical members 33a and 33b. The arm element 25 is rotatable in the disposed position. The number and shape of members constituting coupling members 33 of the arm elements other than the arm element 24 are configured according to the joint of the arm element.

The drive mechanism 40 drives the corresponding joint among the joints J1 to J6. The drive mechanism 40 included in the arm element 24 may be referred to as a drive mechanism 40-5. The drive mechanism 40-5 drives the joint J5. The drive mechanism 40 (drive mechanism 40-5) that drives the joint J5 includes the motor 425, a decelerator 445, the first pulley 465, the second pulley 475, the belt 485, and an angle sensor 495. The motor 425 is the motor 42 included in the drive mechanism 40-5. The decelerator 445 is the decelerator 44 included in the drive mechanism 40-5. The angle sensor 495 is an angle sensor 49 included in the drive mechanism 40-5. In FIG. 3, illustration of the decelerator 445 and the angle sensor 495 are omitted. In FIG. 4, illustration of the internal structure of the motor 425 and the decelerator 445, and the angle sensor 495 is omitted.

The motor 425 rotates a rotation shaft 425b under the control of the robot controller 500 in order to drive the joint J5. The motor 425 is, for example, a servo motor. The decelerator 445 converts a rotational input, which is input from the motor 425, into a rotational output having a low rotational speed. The first pulley 465 is coupled to the rotation shaft 425b of the motor 425. The second pulley 475 is supported by a shaft section 445b of the decelerator 445. As shown in FIG. 4, the decelerator 445 is coupled to a shaft section 25c formed integrally with the arm element 25. As shown in FIGS. 3 and 5, the belt 485 is wound around the first pulley 465 and the second pulley 475. Therefore, the rotational force of the motor 425 can be transmitted to the arm element 25.

As shown in FIG. 2, the angle sensor 49 (495) detects the angular position of an output shaft of the motor 425 as the rotation angle of the joint J5, and outputs the detection value to the control substrate 520 of the robot controller 500. The angle sensor 49 is, for example, a rotary encoder. In addition, the angle sensor 49 is a battery-less encoder that does not require a battery for holding storage of the detection value, and is, for example, a battery-less encoder having a structure using a plurality of gears. Specifically, the angle sensor 49 includes a main shaft gear attached to the output shaft of the motor 425 and first to third countershaft gears meshing with the main shaft gear, and is configured such that the number of teeth of the four gears is an integer having no greatest common divisor other than 1. The angle sensor 49 detects the angular position within one rotation and the number of times of one rotation as the rotation angle from the combination of the positions of the four gears. Note that the angle sensor 49 may be another battery-less encoder, and may be, for example, a battery-less encoder that has a power generation unit using magnetic force or power to hold a detection value in a memory.

Similarly, each arm element 21 to 23 has a main body 31, a coupling member 33, and a drive mechanism 40. The drive mechanism 40 included in the arm element 21 drives the joint J2. The drive mechanism 40 included in the arm element 22 drives the joint J3. The drive mechanism 40 included in the arm element 23 drives the joint J4. The drive mechanism 40 that drives the joint J1 is disposed inside the base 10.

Further, no drive mechanism 40 is provided inside the arm element 26. Therefore, in addition to the drive mechanism 40 for driving the joint J5, another drive mechanism 40 for driving the joint J6 is provided inside the arm element 24.

FIG. 6 is a side view of the arm element 24 shown in FIG. 3 as viewed in the +X direction. FIG. 6 is a side view in a state where the side surface on the −X side of the main body 31 of the arm element 24 is removed. In FIG. 6, a drive mechanism 40 for driving the joint J6 is shown. The drive mechanism 40 for driving the joint J6 may be referred to as a drive mechanism 40-6. The drive mechanism 40 (40-6) that drives the joint J6 includes a motor 426, a decelerator 446, a first pulley 466, a second pulley 476, a belt 486, and an angle sensor 496. The motor 426 is the motor 42 included in the drive mechanism 40-6. The decelerator 446 is a decelerator 44 included in the drive mechanism 40-6. The angle sensor 496 is an angle sensor 49 included in the drive mechanism 40-6. In FIG. 6, in order to show the positional relationship of the motor 426, the first pulley 466, the second pulley 476, and the belt 486, illustration of other components is omitted. The joint J6 rotates around a rotation axis intersecting with the rotation axis of the motor 426. Therefore, the decelerator 446 includes a bevel gear such as a hypoid gear or a worm gear, and converts the rotational direction of power transmitted from the motor 426 into a substantially vertical direction. In addition, the decelerator 446 reduces the rotational speed of the power input from the motor 426.

Next, the positions where the temperature sensor 310 and the heater 320 of the temperature adjuster 300 are installed will be described. As shown in FIGS. 3 and 5, the temperature sensor 310 and the heater 320 for the drive mechanism 40 (drive mechanism 40-5) that drives the joint J5 are disposed between the motor 425 and the decelerator 445 and inside a bottom surface of the main body 31 in the arm element 24. For example, the temperature sensor 310 and the heater 320 are disposed at an intermediate point of a straight line connecting the motor 425 and the decelerator 445.

As described above, the main body 31 is formed by aluminum or an aluminum alloy. Therefore, heat generated from the heater 320 is conducted through the main body 31. As a result, the motor 425 and the decelerator 445 are heated. The joint J5 is also referred to as a first joint. The drive mechanism 40-5 that drives the joint J5 is also referred to as a first drive section. The motor 425 is also referred to as a first motor. The decelerator 445 is also referred to as a first decelerator. The temperature of the drive mechanism 40-5 is also referred to as a first temperature. The target temperature of the drive mechanism 40-5 is also referred to as a first target value. The temperature sensor 310 that measures the temperature of the drive mechanism 40-5 is also referred to as a first temperature measurement section. The heater 320 that heats the drive mechanism 40-5 is also referred to as a first heating section.

Further, as shown in FIG. 6, the temperature sensor 310 and the heater 320 for the drive mechanism 40 (drive mechanism 40-6) that drives the joint J6 are disposed between the motor 426 and the decelerator 446 and inside the upper surface of the main body 31 in the arm element 24. For example, the temperature sensor 310 and the heater 320 are disposed at an intermediate point of a straight line connecting the motor 426 and the decelerator 446. Heat generated from the heater 320 is conducted through the main body 31. As a result, the motor 426 and the decelerator 446 are heated. The joint J6 is also referred to as a second joint. The drive mechanism 40-6 that drives the joint J6 is also referred to as a second drive section. The motor 426 is also referred to as a second motor. The decelerator 446 is also referred to as a second decelerator. The temperature of the drive mechanism 40-6 is also referred to as a second temperature. The target temperature of the drive mechanism 40-6 is also referred to as a second target value. The temperature sensor 310 that measures the temperature of the drive mechanism 40-6 is also referred to as a second temperature measurement section. The heater 320 that heats the drive mechanism 40-6 is also referred to as a second heating section.

Further, the temperature sensors 310 and the heaters 320 for the drive mechanism 40 that drives the joint J1 are disposed on the inner wall surface of the base 10 between the motor 42 and the decelerator 44 inside the base 10. The temperature sensors 310 and the heater 320 for the drive mechanism 40 that drives the joint J2 are disposed between the motor 42 and the decelerator 44, and on an inner side surface of the main body of the arm element 21 inside the main body of the arm element 21. The temperature sensor 310 and the heater 320 for the drive mechanism 40 that drives the joint J3 are disposed between the motor 42 and the decelerator 44, and on an inner side surface of the main body of the arm element 22 inside the main body of the arm element 22. The temperature sensor 310 and the heater 320 for the drive mechanism 40 that drives the joint J4 are disposed between the motor 42 and the decelerator 44, and on an inner side surface of the main body of the arm element 23 inside the main body of the arm element 23.

As described above, the temperature sensor 310 and the heater 320 are provided in the drive mechanism 40 that drives each joint. The temperature adjuster 300 individually controls the amount of heat generation of the heaters 320 so that the measured temperatures approach the target temperatures, that is, the deviation between the measured temperatures and the target temperatures approaches the value of zero, for each drive mechanism 40.

As described above, in the configuration according to the embodiment, by heating the drive mechanism 40, it is possible to prevent a situation in which lubricant used in the drive mechanism 40 hardens and the robot 100 cannot operate. Further, even if the lubricant does not harden, the viscosity of the lubricant increases as the temperature decreases. Even viscosity of a lubricant for use in a low temperature environment increases as the temperature decreases. When the viscosity of the lubricant increases, it becomes difficult for the robot 100 to smoothly operate. When the viscosity of the lubricant increases, for example, sliding of a bearing used in the decelerator 44 of the drive mechanism 40 deteriorates, and as a result, energy loss occurs. However, by heating each drive mechanism 40, it is possible to prevent such a problem from occurring.

In this way, heating of each drive mechanism 40 is individually controlled according to the temperature measured in the vicinity of each drive mechanism 40. Therefore, as compared with a mode in which all the drive mechanisms 40 are uniformly heated, each drive mechanism 40 can be appropriately heated. Thus, each drive mechanism 40 can be stably operated in the low temperature environment.

In the robot 100, the main body 31 of the arm element may be formed by aluminum or an aluminum alloy, and gears, bearings, and the like constituting a part of the drive mechanism 40 may be formed by iron. When the robot 100 is carried in from a normal temperature environment to a low temperature environment, a difference occurs in the shrinkage ratio of each member due to a difference in thermal expansion coefficient between aluminum and iron. This causes the arm 20 to warp and distort. However, since the drive mechanism 40 provided in the robot 100 is heated and controlled so as to maintain the temperature of the robot 100 within a temperature range at which the robot 100 can normally operate, shrinkage of the member can be suppressed.

Further, since one heater 320 is disposed between the motor 42 and the decelerator 44 included in the drive mechanism 40, both the motor 42 and the decelerator 44 can be simultaneously heated by the one heater 320.

As shown in FIGS. 3 and 5, the temperature sensor 310 is configured to measure the temperature at the portion between the position where the motor 425 is disposed and the position where the decelerator 445 is disposed and a preset distance L1 away from the motor 425. The preset distance L1 between the temperature sensor 310 and the motor 425 is also referred to as a first distance. As shown in FIG. 6, the temperature sensor 310 is configured to measure the temperature at the position between the position where the motor 426 is disposed and the position where the decelerator 445 (not shown) is disposed and a preset distance L2 from the motor 426. The preset distance L2 between the temperature sensor 310 and the motor 426 is also referred to as a second distance. Note that the distances L1 and L2 may be equal to or different from each other. In this manner, each temperature sensor 310 is disposed at the distance from the motor 425 included in the drive mechanism 40 to be measured. Accordingly, it is possible to prevent an error value caused by the amount of heat generation generated by the motor 425 from being included in the measured value of the temperature of the drive mechanism 40.

### B1. Other Embodiment 1

In the embodiment, a target temperature is set for each of the six drive mechanisms 40, and temperature control is performed so that the measured temperatures approach the target temperatures. Alternatively, an upper limit value and a lower limit value of the target temperatures may be set for each of the six drive mechanisms 40. The lower limit value of the target temperature set for the drive mechanism 40-5 is also referred to as a first lower limit value. The upper limit value of the target temperature set for the drive mechanism 40-5 is also referred to as a first upper limit value. The lower limit value of the target temperature set for the drive mechanism 40-6 is also referred to as a second lower limit value. The upper limit value of the target temperature set for the drive mechanism 40-6 is also referred to as a second upper limit value.

Specifically, for each of the six drive mechanisms 40, the robot controller 500 sets an intermediate value of a range determined by the upper limit value and the lower limit value of the temperature as the target temperature in the temperature adjuster 300. The temperature adjuster 300 outputs the measured values of the temperatures measured by the six temperature sensors 310 to the robot controller 500. When the received measurement value is not between the lower limit value and the upper limit value set for the drive mechanism 40, the robot controller 500 changes the target temperature for the drive mechanism 40 and sets the changed target temperature in the temperature adjuster 300.

For example, when the received measured value is less than the lower limit value and the difference between the measured value and the lower limit value is equal to or greater than a predetermined first value, the robot controller 500 sets the temperature higher than the target temperature set immediately before as a new target temperature in the temperature adjuster 300. When the received measured value exceeds the upper limit value and the difference between the measured value and the upper limit value is equal to or greater than a predetermined second value, the robot controller 500 sets the temperature lower than the target temperature set immediately before as a new target temperature in the temperature adjuster 300. On the other hand, when the difference between the measured value and the lower limit is not equal to or greater than the first value and when the difference between the measured value and the upper limit is not equal to or greater than the second value, the robot controller 500 does not change the target temperature. This is because, when it is considered that the difference between the upper limit value or the lower limit value and the measured value is not large, it is considered that the temperature of the drive mechanism 40 will be within an appropriate range by the PID control of the temperature adjuster 300 even without changing the target temperature.

Alternatively, when a state in which the received measurement value is below the lower limit value continues for a determined period of time, the robot controller 500 may set a temperature higher than the target temperature set immediately before in the temperature adjuster 300 as a new target temperature. When a state in which the received measurement value is exceed the upper limit value continues for a determined period time, the robot controller 500 may set a temperature lower than the target temperature set immediately before in the temperature adjuster 300 as a new target temperature.

In this manner, since control is performed so as to maintain the temperature of each drive mechanism 40 within the set range in accordance with the temperature of each drive mechanism 40, each drive mechanism 40 can be stably operated.

### B2. Other Embodiment 2

The target temperatures of the six drive mechanisms 40 are the same in the embodiment, the target temperatures of the six drive mechanisms 40 may be set to be different from each other.

An advantage of differentiating the target temperatures of the six drive mechanisms 40 will be described. First, in the robot 100, the motor capacities of the motors 42 of the drive mechanisms 40 provided in the arm elements are different from each other. The motor 42 disposed on the proximal side of the arm 20 has a larger motor capacity than the motor 42 disposed on the tip end side of the arm 20. The motor 42 disposed on the proximal side of the arm 20 is, for example, the motor 42 that drives the joint J1 formed by a coupling section between the base 10 and the arm elements 21. The motor 42 disposed on the tip end side of the arm 20 is, for example, the motor 42 that drives the joint J6. The reason why the motor capacities are made different from each other is as follows. The motor 42 disposed on the proximal side of the arm 20 needs to support other arm elements. On the other hand, the motor 42 disposed at the tip end side of the arm 20 does not need to support other arm elements.

When the six motors 42 perform the same work amount, the amount of heat generation generated per unit time by the motor 42 is proportional to the motor capacity of the motor 42. Therefore, the motor 42 disposed on the tip end side of the arm 20 generates a smaller amount of heat generation per unit time than the motor 42 disposed on the proximal side of the arm 20. Therefore, even if the arm element on the tip end side and the arm element on the proximal side are heated in the same manner, the temperature rise rate per unit time due to heating of the arm element on the tip end side is smaller than that of the arm element on the proximal side. Therefore, the target temperature of the arm element on the tip end side may be set to be higher than the target temperature of the arm element on the proximal side.

In addition, when the motor capacities of the six motors 42 are substantially the same, the amount of heat generation per unit time of the motor 42 itself is proportional to the work amount per unit time of the motor 42. For example, it will be assumed that the motor 42 disposed on the proximal side of the arm 20 has a larger work amount than the motor 42 disposed on the tip end side of the arm 20. In this case, the temperature rise rate per unit time due to heating of the arm element on the proximal side will be larger than that of the arm element on the tip end side. Therefore, the target temperature of the arm element on the tip end side may be set to be higher than the target temperature of the arm element on the proximal side. Further, the adjustment section 330 may perform control such that the amount of heat generation generated per unit time by the heater 320 for heating the arm element on the tip end side is larger than that by the heater 320 for heating the arm element on the proximal side.

For example, it will be assumed that the motor 42 disposed on the tip end side of the arm 20 has a larger work amount than the motor 42 disposed on the proximal side of the arm 20. In this case, a temperature rise rate per unit time due to heating of the arm element on the tip end side will be larger than that of the arm element on the proximal side. Therefore, the target temperature of the arm element of the proximal side may be set higher than the target temperature of the arm element of the tip end side. Further, the adjustment section 330 may perform control such that the amount of heat generation generated per unit time by the heater 320 for heating the arm element on the proximal side is larger than that by the heater 320 for heating the arm element on the tip end side.

In addition, for example, in a case where a target gripped by the robot 100 is a low-temperature object such as frozen food, the heat capacity of the arm element 26 closest to the end effector 70 will be larger than the heat capacities of the other arm elements. In this case, the temperature rise rate per unit time due to heating of the arm element 26 is smaller than that of the other arm elements. Therefore, the target temperature of the arm element 26 may be set higher than the target temperatures of the other arm elements.

### B3. Other Embodiment 3

Further, the amount of heat generation per unit time of the heater 320 may be calculated as follows. Using the computer, calculate in advance the work amount of the drive mechanism 40 based on an operation program that controls the operation of the robot 100. Specifically, for example, for each command included in the operation program, the work amount of the motor 42 that drives each joint is calculated from the displacement amount of each joint, and from rotation speed and torque of the motor 42, of the robot 100 at the time of executing the command. Then, a value obtained by dividing the total work amount at the time of execution of the operation program of each joint by the time required to complete execution of the operation program is obtained as the amount of heat generation generated by the motor 42 per unit time. Further, the amount of heat generation per unit time of the heater 320 according to the amount of heat generation per unit time of the motor 42 is obtained. In this case, the robot controller 500 may control the temperature adjuster 300 so that the motor 42 generates heat at the obtained amount of heat generation per unit time.

Therefore, each drive mechanism 40 is heated by the amount of heat generation per unit time according to the work amount in each drive mechanism 40 proportional to the amount of heat generation of each drive mechanism 40. As described above, since each drive mechanism 40 is heated by the necessary amount according to the work amount of each drive mechanism 40, the drive unit can be efficiently heated.

### B4. Other Embodiment 4

In the embodiment, an example in which the temperature sensor 310 and the heater 320 are disposed at an intermediate point of a straight line connecting the motor 42 and the decelerator 44 has been described. However, the temperature sensor 310 and the heater 320 may not be disposed at an intermediate point. The temperature sensor 310 and the heater 320 may be disposed closer to the larger one of the motor 42 and the decelerator 44. Here, the larger one of the motor 42 and the decelerator 44 means the one having a larger volume. The motor 42 and the decelerator 44 can be uniformly heated by bringing the heater 320 closer to the one of the motor 42 and the decelerator 44 that has the larger volume than the other, instead of closer to the one having a smaller volume.

### B5. Other Embodiment 5

In the embodiment, an example has been described in which each temperature sensor 310 is disposed at a distance from the motor 425 included in the drive mechanism 40 to be measured has been described. However, the temperature sensor 310 may be disposed without a distance from the motor 425 included in the drive mechanism 40 to be measured. For example, the amount of heat generation of the motor 42 is calculated in advance as a correction value by a simulation or the like using a computer. The CPU 523 of the control substrate 520 may obtain the measurement value of the temperature of the drive mechanism 40 by subtracting the correction value from the measurement value of the temperature sensor 310 supplied from the adjustment section 330.

### B6. Other Embodiment 6

Each heater 320 has a fuse having a function of cutting off or limiting a supplied current according to a temperature rise. A fuse included in the heater 320 that heats the drive mechanism 40-5 is also referred to as a first protection element. A fuse included in the heater 320 that heats the drive mechanism 40-6 is also referred to as a second protection element. Since each heater 320 has a fuse, the current supply to the heater 320 can be stopped without depending on the control of the adjustment section 330, for example. Therefore, overheating of the drive mechanism 40 can be prevented. For example, when the motor 42 is a servo motor, the motor 42 includes an encoder. It will be assumed that the limit temperature of the encoder is 100° C. In such a case, by using the fuse having a melting point of 80° C., it is possible to prevent the drive mechanism 40 from being overheated such that the encoder of the motor 42 reaches the limit temperature.

### B7. Other Embodiment 7

There is a case where an instruction to stop the robot 100 is notified to the robot controller 500 while the robot 100 is operating. For example, when an emergency stop button provided at a loading port of the work is depressed, the robot controller 500 is notified of an instruction to stop the robot 100. In this case, the robot controller 500 notifies the temperature adjuster 300 that heating is to be stopped. Therefore, the temperature adjuster 300 stops heating by the six heaters 320 disposed in the arm 20. By stopping heating when the operation of the robot 100 is stopped, each drive mechanism 40 is not unnecessarily heated.

In addition, a line for supplying electric power from a power source to each drive mechanism 40 and a line for supplying electric power from the power source to the heater 320 can be configured to be different. For example, in some cases, the operation speed of the robot 100 is limited or the operation of the robot 100 is stopped in response to a signal from a sensor that detects whether or not there is a person around the robot 100. It is assumed that the period in which the operation speed is limited is a very short period and that the normal operation of the robot 100 will be resumed again. When heating by the heater 320 is not continued, it is difficult for the robot 100 to smoothly operate at the time of restart. Therefore, by providing separate the lines for supplying electric power to each drive mechanism 40 of the robot 100 and the lines for supplying electric power to each heater 320, for example, even when the electric power supply to each drive mechanism 40 is stopped, heating of each drive mechanism 40 can be continued. The line that supplies electric power to the drive mechanism 40 is also referred to as a first line. The line that supplies electric power to the heater 320 is also referred to as a second line.

### B8. Other Embodiment 8

The temperature adjuster 300 may further include a display panel that displays the temperature measured by the temperature sensor 310. The display panel is also referred to as a display section. The temperature adjuster 300 displays the temperatures measured in each drive mechanism 40 on the display panel. Since the temperature of each drive mechanism 40 can be visually recognized, user can easily monitor the temperature of each drive mechanism 40.

### B9. Other Embodiment 9

In the embodiment, an example in which the robot controller 500 sets the target temperature stored in the memory 521 to the temperature adjuster 300 has been described. However, the robot controller 500 may set a temperature higher than the target temperature stored in the memory 521 by a preset value in the temperature adjuster 300. For example, the robot controller 500 can set the temperature of the target temperature +2° C. to the temperature adjuster 300. As described above, by setting the temperature to be set in the temperature adjuster 300 to be slightly higher than the target temperature specified in advance, it is possible to perform temperature management with a margin, for example, in preparation for a case where a sudden temperature drop occurs in an environment in which the robot 100 works.

### B10. Other Embodiment 10

Alternatively, heating of the drive mechanism 40 may be performed as follows. For example, by simulation using a computer, the heat release amount per unit time of each drive mechanism 40 according to the ambient temperature of the robot 100 is calculated in advance. At this time, assuming that the work amount of each drive mechanism 40 and the amount of heat generation of the heater 320 are not present, the heat release amount per unit time is calculated. An ambient temperature sensor for measuring the ambient temperature of the robot 100 is installed in the vicinity of the robot 100. The amount of heat generation per unit time of the heater 320 is controlled so that the heat release amount per unit time of the drive mechanism 40 obtained from the ambient temperature measured by the ambient temperature sensor coincides with the sum of the amount of heat generation per unit time of the drive mechanism 40 and the amount of heat generation per unit time of the heater 320. The control described above is performed for each drive mechanism 40.

### B11. Other Embodiment 11

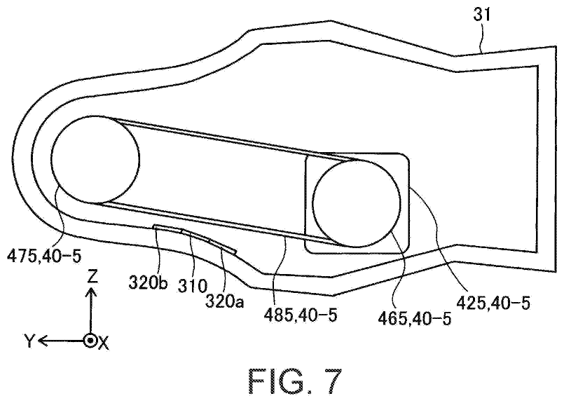

In addition, although an example in which one heater 320 is installed between the motor 42 and the decelerator 44 included in the drive mechanism 40 has been described in the embodiment (refer to FIGS. 3 and 5), the number of heaters for heating one drive mechanism 40 may be two or more. FIG. 7 is a view showing an installation position of a heater in an other embodiment 11. As shown in FIG. 7, the temperature sensors 310, a heater 320a, and a heater 320b for the drive mechanism 40 that drives the joint J5 are disposed between the motor 42 and the decelerator 44 and to the inside of the bottom surface of the main body 31, in the arm element 24.

The heater 320 may be installed only in some of the six drive mechanisms 40. For example, since the motor 42 disposed on the tip end side of the arm 20 generates a smaller amount of heat than does the motor 42 disposed on the proximal side of the arm 20, the heater 320 may be disposed only on the tip end side of the arm 20. Further, when the motor 42 disposed on the proximal side of the arm 20 is not operated, the amount of heat generation is small, and thus the heater 320 may be disposed only on the proximal side of the arm 20. Further, when the arm 20 is made of a material through which heat is easily conducted, the heater 320 may be installed only in the three drive mechanisms 40 of the arm elements 21, 23, and 25 or the three drive mechanisms 40 of the arm elements 22, 24, and 26, without installing a heater 320 in adjacent arm elements. In a case where the angle sensor 49 is not a battery-less encoder and a battery for holding a detection value is disposed in the drive mechanism 40 or in the robot 100 other than the drive mechanism 40, the heater 320 may be disposed near the battery. Accordingly, a decrease in the battery residual quantity due to low temperature can be suppressed.

In the embodiment, an example in which the main body 31 of the arm element is a housing formed by aluminum or an aluminum alloy has been described. However, the main body 31 of the arm element need not be formed of the same material. For example, in the main body 31 shown in FIGS. 3 and 5, only the bottom surface may be formed by aluminum or an aluminum alloy, and the portions other than the bottom surface of the main body 31 may be formed of resin. In this case, it is desirable to use a resin, such as polycarbonate, that maintains its properties well at low temperatures. By forming the bottom surface of the main body 31 where the heater 320 is disposed from a material having a higher thermal conductivity than the other portions, the arm element can be efficiently heated. Further, by using resin, the weight of the arm element can be reduced.

Further, the housing constituting the main body 31 of the arm element may be formed so as to have a double wall with an air layer or a heat insulating material interposed therebetween. This can prevent heat inside the arm element from being dissipated to the outside. For example, when the robot 100 works in a frozen food production line, it is possible to prevent it from affecting temperature management in the production line.

Further, when the robot 100 is carried in from the normal temperature environment to the low temperature environment, it is conceivable that condensation occurs inside the robot 100. Therefore, sponges for absorbing water may be arranged in the vicinity of the substrate provided with the motor 42 and the encoder included in the motor 42 and the substrate provided with other various sensors. Alternatively, before the robot 100 is carried from the normal temperature environment to the low temperature environment, the air in the internal space of the arm element can be removed in advance by a vacuum pump. Alternatively, before the robot 100 is carried from the normal temperature environment to the low temperature environment, dry air can be supplied to the internal space of the arm element by an air compressor. Therefore, it is possible to prevent problems from occurring in the motor 42, the encoder, and the various sensors due to condensation.

An example of a six axis vertically articulated robot has been described in the embodiment, but the robot 100 may be a SCARA robot.

The present disclosure is not limited to the above described embodiments, and can be realized in various configurations without departing from the spirit thereof. For example, the technical features in the embodiments corresponding to the technical features in each aspect described in the Summary can be appropriately replaced or combined in order to solve a part or all of the problems described above or to achieve a part or all of the effects described above. In addition, unless the technical features are described as essential features in the present specification, the technical features can be appropriately deleted.

### C. Other Forms

(1) According to one aspect of the present disclosure, a robot system is provided. This robot system includes a robot arm and a control section that controls an operation of the robot arm and a temperature of the robot arm, wherein the robot arm includes a first joint, a second joint that is different from the first joint, a first driving section that drives the first joint, and a second drive section that is different from the first drive section and that drives the second joint and the control section includes a first temperature measurement section that measures a first temperature of the first drive section, a first heating section that heats the first drive section, a second temperature measurement section that is different from the first temperature measurement section and that measures a second temperature of the second drive section, a second heating section that is different from the first heating section and that heats the second drive section, and an adjustment section that controls heat generation of the first heating section so as to bring the first temperature of the first drive section close to a first target value set in advance and that controls heat generation of the second heating section that the second temperature of the second drive section approaches a second target value set in advance.

According to the above aspect, since the heating of each drive section is controlled based on the temperature of each drive section, each drive section can be appropriately heated compared with the embodiment in which all drive sections are uniformly heated. This makes it possible to stably operate the robot arm in the low temperature environment.

(2) The control section of the robot system according to the above aspect may perform the following controls, controlling heat generation of the first heating section so as to maintain the first temperature of the first drive section between a first lower limit value set in advance and a first upper limit value set in advance and controlling heat generation of the second heating section so as to maintain the second temperature of the second drive section between a second lower limit value set in advance and a second upper limit value set in advance.

According to the above aspect, since the heating section is controlled so that the temperature of each driving section is maintained within a set range based on the temperature of each driving section, each driving section can be stably operated.

(3) The control section of the robot system according to the above aspect may perform the following controls, controlling the first heating section to generate heat in an amount of heat generation per unit time of the first heating section calculated according to a work amount of the first drive section calculated based on an operation program for operating the robot arm and controlling the second heating section to generate heat in an amount of heat generation per unit time of the second heating section calculated according to a work amount of the second drive section calculated based on the operation program.

According to the above aspect, each drive section is heated with the amount of heat generation generated per unit time corresponding to the work amount in each drive section proportional to the amount of heat generation generated in each drive section. In this way, since each drive section is heated by a necessary amount in accordance with the work amount of each drive section, it is possible to efficiently heat each drive section.

(4) The robot system according to the above aspect may have the following configuration, the first drive section includes a first motor and a first decelerator, the second drive section includes a second motor and a second decelerator, the first heating section is disposed between a position where the first motor is disposed and a position where the first decelerator is disposed, and the second heating section is disposed between a position where the second motor is disposed and a position where the second decelerator is disposed.

According to the above aspect, since the heating section is disposed between the motor and the decelerator, both the motor and the decelerator can be simultaneously heated by one heating section.

(5) The robot system according to the above aspect may have the following configuration, the first temperature measurement section is configured to measure a temperature of a portion that is between a position where the first motor is disposed and a position where the first decelerator is disposed and that is separated from the first motor by a first distance set in advance and the second temperature measurement section is configured to measure a temperature of a portion that is between a position where the second motor is disposed and a position where the second decelerator is disposed and that is separated from the second motor by a second distance set in advance.

By disposing each temperature measurement section at a distance from the motor included in the drive section to be measured, it is possible to suppress an error value caused by the amount of heat generation generated by the motor from being included in the measured value of the temperature of the drive section.

(6) The robot system according to the above aspect may have the following configuration, the first heating section generates heat by being supplied with a current from a power supply, the second heating section generates heat by being supplied with a current from the power supply, the first heating section includes a first protection element having a function of cutting off or limiting the current from the power supply in accordance with a temperature rise, and the second heating section includes a second protection element that having a function of cutting off or limiting the current from the power supply in accordance with a temperature rise.

According to the above aspect, since the first heating section and the second heating section each include the protection element that cuts off or limits the current from the power supply according to the temperature rise, the current supply to the first heating section and the second heating section can be stopped without depending on the control of the control section. Therefore, it is possible to prevent the first drive section and the second drive section from being overheated.

(7) The robot system according to the above aspect may have the following configuration, when an instruction to stop the robot arm is issued during operation of the robot arm, the control section stops heating of the first drive section by the first heating section and heating of the second drive section by the second heating section.

According to the above aspect, for example, when the robot is urgently stopped, it is possible to prevent the temperatures of the first drive section and the second drive section from being unnecessarily heated by stopping heating.

(8) The robot system according to the above aspect may have the following configuration, it further includes a display section that displays the temperature and the control section causes the display section to display the measured first temperature of the first drive section and the measured second temperature of the second drive section.

According to the above aspect, since the temperature of the first drive section and the temperature of the second drive section can be visually recognized, for example, user can easily monitor the temperatures of the first drive section and the second drive section.

(9) The robot system according to the above aspect may have the following configuration, a first line that supplies electric power from the power source to the first drive section and the second drive section and a second line that supplies electric power from the power source to the first heating section and the second heating section are different.

According to the above aspect, since the line for supplying electric power to each drive section of the robot arm and each line for supplying electric power to each heating section are separate lines, for example, in a case where the robot is urgently stopped, even in a case where the electric power supply to each drive section is stopped, it is possible to continue heating each drive section.

(10) The robot system according to the above aspect may have the following configuration, the first drive section and the second drive section each include a battery-less encoder and the robot arm performs work in a low temperature environment.

According to the above aspect, since each drive section includes the battery-less encoder that is less likely to be affected by low temperature, work can be performed even in the low temperature environment.

What is claimed is:

1. A robot system comprising:
a robot arm and
a control section that controls an operation of the robot arm and a temperature of the robot arm, wherein
the robot arm includes
a first joint,
a second joint that is different from the first joint,
a first driving section that drives the first joint, and
a second drive section that is different from the first drive section and that drives the second joint and
the control section includes
a first temperature measurement section that measures a first temperature of the first drive section,
a first heating section that heats the first drive section,
a second temperature measurement section that is different from the first temperature measurement section and that measures a second temperature of the second drive section,
a second heating section that is different from the first heating section and that heats the second drive section, and
an adjustment section that controls the first heating section so as to bring the first temperature of the first drive section close to a first target value set in advance and that controls the second heating section that the second temperature of the second drive section approaches a second target value set in advance.

2. The robot system according to claim 1, wherein
the control section performs the following controls,
controlling the first heating section so as to maintain the first temperature of the first drive section between a first lower limit value set in advance and a first upper limit value set in advance and
controlling the second heating section so as to maintain the second temperature of the second drive section between a second lower limit value set in advance and a second upper limit value set in advance.

3. The robot system according to claim 1, wherein
the control section performs the following controls,
controlling the first heating section to generate heat in an amount of heat generation per unit time of the first heating section calculated according to a work amount of the first drive section calculated based on an operation program for operating the robot arm and
controlling the second heating section to generate heat in an amount of heat generation per unit time of the second heating section calculated according to a work amount of the second drive section calculated based on the operation program.

4. The robot system according to claim 1, wherein
the first drive section includes a first motor and a first decelerator,
the second drive section includes a second motor and a second decelerator,
the first heating section is disposed between a position where the first motor is disposed and a position where the first decelerator is disposed, and
the second heating section is disposed between a position where the second motor is disposed and a position where the second decelerator is disposed.

5. The robot system according to claim 4, wherein
the first temperature measurement section is configured to measure a temperature of a portion that is between a position where the first motor is disposed and a position where the first decelerator is disposed and that is separated from the first motor by a first distance set in advance and
the second temperature measurement section is configured to measure a temperature of a portion that is between a position where the second motor is disposed and a position where the second decelerator is disposed and that is separated from the second motor by a second distance set in advance.

6. The robot system according to claim 1, wherein
the first heating section generates heat by being supplied with a current from a power supply,
the second heating section generates heat by being supplied with a current from the power supply,
the first heating section includes a first protection element that cutting off or limiting the current from the power supply in accordance with a temperature rise, and
the second heating section includes a second protection element that cutting off or limiting the current from the power supply in accordance with a temperature rise.

7. The robot system according to claim 1, wherein
when an instruction to stop the robot arm is issued during operation of the robot arm, the control section stops heating of the first drive section by the first heating section and heating of the second drive section by the second heating section.

8. The robot system according to claim 1, further comprising:
a display section that displays the temperature, wherein
the control section causes the display section to display the measured first temperature of the first drive section and the measured second temperature of the second drive section.

9. The robot system according to claim 6, wherein
a first line that supplies electric power from the power source to the first drive section and the second drive section and a second line that supplies electric power from the power source to the first heating section and the second heating section are different.

10. The robot system according to claim 1, wherein
the first drive section and the second drive section each include a battery-less encoder and
the robot arm performs work in a low temperature environment.
